(19) United States
(12) Patent Application Publication
(10) Pub. No.: US 2016/0198768 A1
(43) Pub. Date: Jul. 14, 2016

(54) ATOMIZATION ASSEMBLY AND ELECTRONIC CIGARETTE

(71) Applicant: KIMREE HI-TECH INC., Road Town, Tortola (VG)

(72) Inventor: Qiuming Liu, Shenzhen, Guangdong (CN)

(73) Assignee: Kimree Hi-Tech Inc., Tortola (VG)

(21) Appl. No.: 14/913,379

(22) PCT Filed: Aug. 21, 2013
(86) PCT No.: PCT/CN2013/081977

§ 371 Date: Feb. 22, 2016

(51) Int. Cl. A24F 47/00; H05B 3/00; H05B 1/02

(52) U.S. Cl. CPC A24F 47/008; H05B 1/0244; H05B 3/0014

(57) ABSTRACT

An atomization assembly and an electronic cigarette with the atomization assembly. The atomization assembly comprises an oil guide member, a heating member wound round on the oil guide member, and a first electrically-conductive connecting member and a second electrically-conductive connecting member are being connected with two ends of the heating member respectively; the heating member includes at least one plane, and one plane in the at least one plane is attached to and wound towards an outside surface of the oil guide member with a close fit. Since the heating member is designed with at least one plane and the plane is wound towards an outer surface of the oil guide member, the contact area between the heating member and the oil guide member is increased so that the amount of atomization generated per unit time is improved, the atomization effect is improved, and user experience is enhanced.

### FIELD OF THE INVENTION

The present invention relates to a field of daily electronic products, and more particularly relates to an atomization assembly and an electronic cigarette.

### BACKGROUND OF THE INVENTION

Electronic cigarettes are mainly configured for quitting smoking and substituting smoking. The electronic cigarettes available on the market at present include a battery assembly and an atomization assembly, and the battery assembly is detachably connected with the atomization assembly or shares a common outer sleeve with the atomization assembly. The atomization assembly of electronic cigarette includes a heating member. When the electronic cigarette is working, the heating member is heated, so that tobacco juice is atomized to realize an effect of generating smoke.

The heating member in the prior art is a columned heating wire with a circular-shaped cross section, which makes the connecting area between the heating member and an oil guide member in a form of line. So the connecting area between the heating member and the oil guide member is small, and the amount of atomization generated per unit time is small, which makes inhaling a puff of smoke laborious and time consuming, and leads to a bad user experience. Besides, the columned heating wire can easily lead to poor contact with electrically-conductive connecting member, which affect normal operation of the electronic cigarette and reduces the service life of the electronic cigarette.

### SUMMARY OF THE INVENTION

One of objective of the present invention is to provide an atomization assembly, and another of objective is to provide an electronic cigarette containing the above atomization assembly, aiming at the defect that the amount of atomization is small and easily lead to poor contact with electrically-conductive connecting members.

The technical solutions of the present invention for solving the technical problems are as follows.

In one aspect, an atomization assembly is provided, which is used for combining a battery assembly to form an electronic cigarette, comprising an oil guide member, a heating member that is wound round the oil guide member, and two ends of the heating member are respectively connected with a first electrically-conductive connecting member and a second electrically-conductive connecting member. The heating member includes at least one plane, and one plane in the at least one plane is attached to and wound towards an outside surface of the oil guide member with a close fit.

In the atomization assembly of the present invention, a cross section of the heating member is polygon.

In the atomization assembly of the present invention, the cross section of the heating member is rectangle.

In the atomization assembly of the present invention, the length of the cross section of the heating member is ranged from 0.3 mm to 1 mm, and the width of the cross section of the heating member is ranged from 0.05 mm to 0.2 mm.

In the atomization assembly of the present invention, two ends of the heating member are riveted to the first electrically-conductive connecting member and the second electrically-conductive connecting member with riveting terminals respectively.

In the atomization assembly of the present invention, cross sections of the first electrically-conductive connecting member and the second electrically-conductive connecting member are polygon respectively.

In the atomization assembly of the present invention, cross sections of the first electrically-conductive connecting member and the second electrically-conductive connecting member are circular respectively.

In the atomization assembly of the present invention, a first hole and a second hole are defined on two ends of the heating member respectively. Cross section sizes of the first hole and the second hole are respectively greater than those of the first electrically-conductive connecting member and the second electrically-conductive connecting member, one end of the first electrically-conductive connecting member and the second electrically-conductive connecting member respectively passes through the first hole and the second hole, and is respectively fixed connection with two ends of the heating member.

In the atomization assembly of the present invention, surfaces of the first electrically-conductive connecting member and the second electrically-conductive connecting member are respectively coated with well-distributed insulating layers.

In the atomization assembly of the present invention, the heating member is one of a neckel heating member, a chromel heating member, and a tungsten heating member.

In the atomization assembly of the present invention, the first electrically-conductive connecting member and the second electrically-conductive connecting member are made one of materials selected from gold, silver, and copper.

In another aspect, an electronic cigarette is provided, and comprises an atomization assembly and a battery assembly connected with the atomization assembly. The atomization assembly comprises an oil guide member, a heating member that is wound round the oil guide member, and two ends of the heating member are connected with a first electrically-conductive connecting member and a second electrically-conductive connecting member respectively. The heating member includes at least one plane, and one plane in the at least one plane is attached to and wound towards an outside surface of the oil guide member with a close fit.

In the electronic cigarette of the present invention, a cross section of the heating member is polygon.

In the electronic cigarette of the present invention, the cross section of the heating member is rectangle, and the length of the cross section of the heating member is ranged from 0.3 mm to 1 mm, and the width of the cross section of the heating member is ranged from 0.05 mm to 0.2 mm.

In the electronic cigarette of the present invention, two ends of the heating member are riveted to the first electrically-conductive connecting member and the second electrically-conductive connecting member with riveting terminals respectively.

In the electronic cigarette of the present invention, cross sections of the first electrically-conductive connecting member and the second electrically-conductive connecting member are rectangle or circular respectively.

In the electronic cigarette of the present invention, the atomization assembly further comprises a first electrode and a second electrode. The first electrically-conductive connecting member and the second electrically-conductive connecting member are bent from two ends of the heating member in the same direction and are extended to the first electrode and the second electrode to form conductive connections.

In the electronic cigarette of the present invention, the atomization assembly is detachably connected with the battery assembly.

In the electronic cigarette of the present invention, the atomization assembly and the battery assembly are fixed to each other to form an integral forming structure.

By implementing the atomization assembly in the present invention, the following advantages can be achieved. With redesigning the shape of the heating member, the contact area between the heating member and the oil guiding member is increased; the amount of atomization generated per unit time is improved, atomization effect is improved; and user experience is enhanced. Besides, it is conducive to the connection with the electrically-conductive connecting members, more particularly in favor of riveting, and the service life of the electronic cigarette is improved.

### BRIEF DESCRIPTION OF THE DRAWINGS

The present invention will be further described with reference to the accompanying drawings and embodiments in the following, in the accompanying drawings:

FIG. 1 is a section view of an electronic cigarette of the present invention;

FIG. 2 is a section view of an atomization assembly of the present invention;

FIG. 3 is a schematic block diagram of a heating member, a first electrically-conductive connecting member and a second electrically-conductive connecting member of the present invention; and

FIG. 4 is a schematic block diagram of an outtake of the present invention.

### DETAILED DESCRIPTION OF THE PREFERRED EMBODIMENT

To make the technical feature, objective and effect of the present invention be understood more clearly, now the specific implementation of the present invention is described in detail with reference to the accompanying drawings and embodiments.

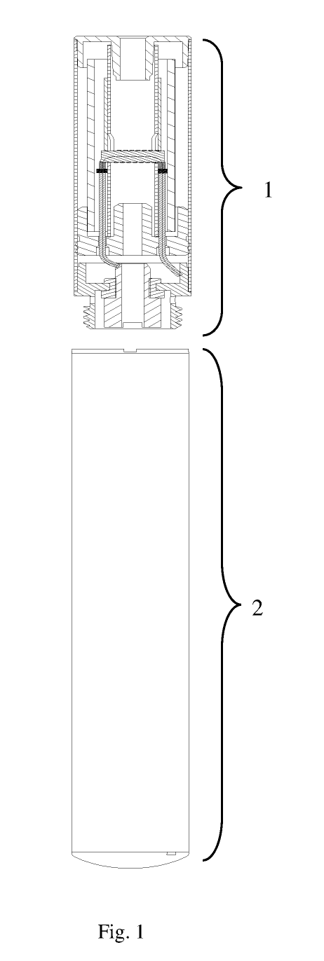

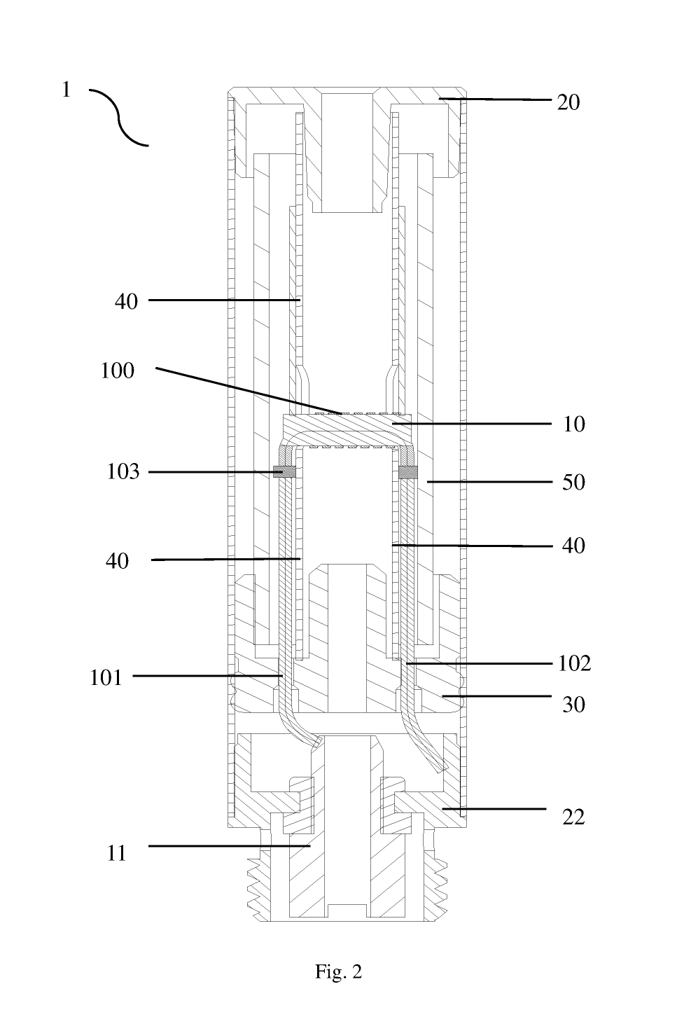

As shown in FIGS. 1 and 2, an electronic cigarette comprises an atomization assembly 1 and a battery assembly 2. A suction nozzle cap 20 is arranged on one end portion of the atomization assembly 1, and a first electrode 11 and a second electrode 22 that are used to connect with the battery assembly 2 are arranged on the other end portion of the atomization assembly 1.

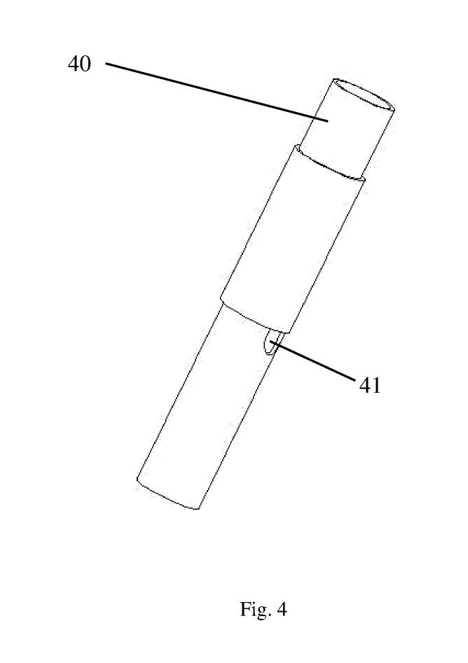

An atomizing seat 30 is located near the inner side of the first electrode 11 and the second electrode 22. An outtake 40 is located between the suction nozzle cap 20 and the atomizing seat 30, and oil storage cotton 50 surrounds the outer surface of the outtake 40. As shown in FIG. 4, two through-holes 41 are defined on the tube wall of the outtake 40 in the radial direction, and the two through-holes 41 are opposite to each other. The through-holes 41 are used for an oil guiding member 10 to be inserted, and two ends of the oil guiding member 10 are closed to the oil storage cotton 50 respectively. The oil storage cotton 50 provides tobacco juice for the oil guiding member 10.

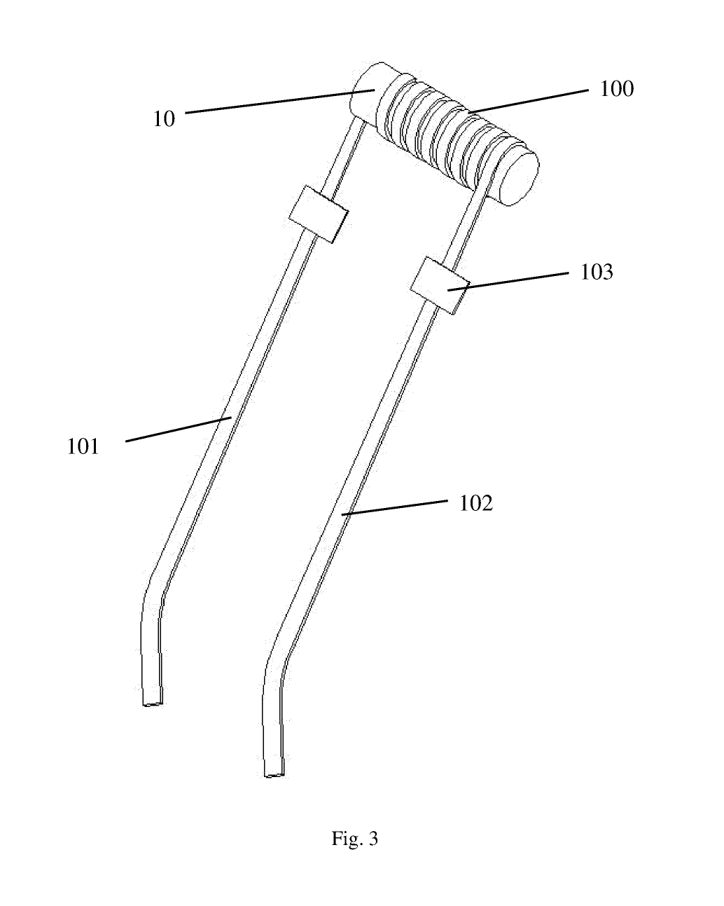

As shown in FIGS. 2 and FIG. 3, a heating member 100 is wound round the oil guide member 10, and preferably it is uniformly woud round the oil guide member 10. Two ends of the heating member 100 are connected to a first electrically-conductive connecting member 101 and a second electrically-conductive connecting member 102 respectively. The first electrically-conductive connecting member 101 and the second electrically-conductive connecting member 102 are clamped between the outtake 40 and the oil storage cotton 50 respectively. Two through-holes (not shown in figures) are defined on the atomizing seat 30 and are used for passing through the first electrically-conductive connecting member 101 and the second electrically-conductive connecting member 102. The first electrically-conductive connecting member 101 and the second electrically-conductive connecting member 102 are respectively bent from two ends of the heating member 100 in the same direction and are extended to the first electrode 11 and the second electrode 22 via passing through two through-holes to form conductive connections.

The battery assembly 2 of the electronic cigarette is electrically connected to the first electrically-conductive connecting member 101 and the second electrically-conductive connecting member 102 via the first electrode 11 and the second electrode 12, and further supplies power to the heating member 100 to heat the oil guiding member 10 for generating atomizing oil smoke.

Wherein the atomization assembly 1 and the battery assembly 2 are detachably connected to each other or fixed to each other to form an integral forming structure. That is when the atomization assembly 1 and the battery assembly 2 are integrated as a whole by sharing a common outer sleeve, it is a disposable electronic cigarette.

The following is a detailed description of different kinds of the heating member 100, the first electrically-conductive connecting member 101 and the second electrically-conductive connecting member 102:

### Embodiment 1

The shape of the heating member 100 is flat, and it includes at least one plane. The shape of the cross section of the heating member 100 is selected from semicircle, semiellipse, polygon, etc. As shown in FIG. 3, a plane of the heating member 100 is towards an outside surface of the oil guiding member 10, and is attached to and wound towards to the outside surface of the oil guide member 10 with a close fit, which improves the amount of atomization generated per unit time, improves atomization effect, and enhances the user experience. Wherein the shape of the cross section of the heating member 100 is preferably polygonal, such as rectangular, square, trapezoidal, symmetrical hexagonal etc., which is easy for production.

Preferably, the shape of cross section of the heating member 100 is rectangular, the length is ranged from 0.3 mm to 1 mm, and the width is ranged from 0.05 mm to 0.2 mm.

The shapes of cross sections of the first electrically-conductive connecting member 101 and the second electrically-conductive connecting member 102 are polygonal respectively, such as rectangular, square, trapezoidal, symmetrical hexagonal, etc.; and the shape is preferably to be rectangular. The shape and dimension of the cross sections of the first electrically-conductive connecting member 101 and the second electrically-conductive connecting member 102 can be the same as or different from those of the heating member 100. This will make the heating member 100 be easily connected with the first electrically-conductive connecting member 101 and the second electrically-conductive connecting member 102 respectively, particularly in favor of riveting. Mainly for increasing the overlapped area when the heating member 100 connects to the first electrically-conductive connecting member 101 and the second electrically-conductive connecting member 102 respectively, it can reduce the rejection rate of riveting and be helpful for lean production.

Two ends of the heating member 100 are riveted to the first electrically-conductive connecting member 101 and the second electrically-conductive connecting member 102 with riveting terminals 103 respectively. Specifically, partially overlapping one end of the first electrically-conductive connecting member 101 and the second electrically-conductive connecting member 102 with two ends of the heating member 100 respectively, then coating the overlapping areas with riveting terminals 103 and compacting the riveting terminals 103 to connect the first electrically-conductive connecting member 101 and the second electrically-conductive connecting member 102 with the heating member 100. The riveting terminals 103 can be replaced with rivets to rivet the first electrically-conductive connecting member 101 with one end of the heating member 100 and the second electrically-conductive connecting member 102 with the other end of the heating member 100.

Wherein, surfaces of the first electrically-conductive connecting member 101 and the second electrically-conductive connecting member 102 are respectively coated with well-distributed insulating layers (not shown in figures). The insulating layers are insulating varnish sprayed on the surfaces of the first electrically-conductive connecting member 101 and the second electrically-conductive connecting member 102, as rubber paint, pastic paint, etc. The insulating layers can also be insulation sleeve sheathed on the surfaces of the first electrically-conductive connecting member 101 and the second electrically-conductive connecting member 102 respectively, as rubber sleeve, silica gel sleeve, etc.

The heating member 100 is one of a neckel heating member, a chromel heating member, and a tungsten heating member. The first electrically-conductive connecting member 101 and the second electrically-conductive connecting member 102 are made one of materials selected from gold, silver, and copper.

### Embodiment 2

Embodiment 2 differs from embodiment 1 in that the first electrically-conductive connecting member 101 and the second electrically-conductive connecting member 102 are both in a shape of cylinder; the shapes of the cross sections of them are circular with a diameter is ranged from 0.2 mm to 5 mm. Similarly, it can be easy to connect the heating member 100 with the first electrically-conductive connecting member 101 and the second electrically-conductive connecting member 102 respectively.

Two ends of the heating member 100 are directly riveted to the first electrically-conductive connecting member 101 and the second electrically-conductive connecting member 102 without using the riveting terminals 103 respectively. One end of the first electrically-conductive connecting member 101 is coated with one end of the heating member 100, and one end of the second electrically-conductive connecting member 102 is coated with the other end of the heating member 100, then directly compacting coated areas to connect the first electrically-conductive connecting member 101 and the second electrically-conductive connecting member 102 with the heating member 100. In this manner, the riveting terminals 103 are replaced by two ends of the heating member 100. This kind of riveting can also reduce the rejection rate of riveting and be helpful for lean production.

The connection between the heating member 100 and the first electrically-conductive connecting member 101 and the second electrically-conductive connecting member 102 is that a first hole and a second hole (not shown in figures) are defined on two ends of the heating member 100 respectively, the cross section sizes of the first hole and the second hole are respectively greater than those of the first electrically-conductive connecting member 101 and the second electrically-conductive connecting member 102, one end of the first electrically-conductive connecting member 101 and the second electrically-conductive connecting member 102 respectively passes through the first hole and the second hole of two ends of the heating member 100, and is respectively fixed connection with two ends of the heating member 100. It can reduce the bad contact between the heating member 100 and the electrically-conductive connecting members.

It should be understood that any improve or transform according to the above description, for the ordinary technical personnel in this field, shall be within the scope of the invention, and be protected by the accompanying claims.

1. An atomization assembly, configured to be connected with a battery assembly (2) to form an electronic cigarette, comprising:
an oil guide member (10);
a heating member (100) wound round the oil guide member (10);
a first electrically-conductive connecting member (101) and a second electrically-conductive connecting member (102) are being connected with two ends of the heating member (100) respectively; and
wherein the heating member (100) includes at least one plane, and one plane in the at least one plane is attached to and wound towards an outside surface of the oil guide member (10) with a close fit.

2. The atomization assembly according to claim 1, wherein a shape of a cross section of the heating member (100) is polygonal.

3. The atomization assembly according to claim 2, wherein the shape of the cross section of the heating member (100) is rectangular.

4. The atomization assembly according to claim 3, wherein the length of the cross section of the heating member (100) is ranged from 0.3 mm to 1 mm, and the width of the cross section of the heating member (100) is ranged from 0.05 mm to 0.2 mm.

5. The atomization assembly according to claim 1, wherein two ends of the heating member (100) is riveted to the first electrically-conductive connecting member (101) and the second electrically-conductive connecting member (102) with riveting terminals (103) respectively.

6. The atomization assembly according to claim 5, wherein shapes of cross sections of the first electrically-conductive connecting member (101) and the second electrically-conductive connecting member (102) are polygonal respectively.

7. The atomization assembly according to claim 1, wherein shapes of cross sections of the first electrically-conductive connecting member (101) and the second electrically-conductive connecting member (101) are circular respectively.

8. The atomization assembly according to claim 7, wherein a first hole and a second hole are defined on two ends of the heating member (100) respectively;
cross section sizes of the first hole and the second hole are respectively greater than those of the first electrically-conductive connecting member (101) and the second electrically-conductive connecting member (102), one end of the first electrically-conductive connecting member (101) and the second electrically-conductive connecting member (102) respectively passes through the first hole and the second hole, and is respectively fixed connection with two ends of the heating member (100).

9. The atomization assembly according to claim 1, wherein surfaces of the first electrically-conductive connecting member (101) and the second electrically-conductive connecting member (102) are coated with well-distributed insulating layers respectively.

10. The atomization assembly according to claim 1, wherein the heating member (100) is one of a neckel heating member, a chromel heating member, and a tungsten heating member.

11. The atomization assembly according to claim 1, wherein the first electrically-conductive connecting member (101) and the second electrically-conductive connecting member (102) are made one of materials selected from gold, silver, and copper;
wherein the first electrically-conductive connecting member (101) and the second electrically-conductive connecting member (102) are clamped between an outtake (40) and an oil storage cotton (50) respectively; two through-holes are defined on an atomizing seat (30) and are used for passing through the first electrically-conductive connecting member (101) and the second electrically-conductive connecting member (102);
wherein the first electrically-conductive connecting member (101) and the second electrically-conductive connecting member (102) are respectively bent from two ends of the heating member (100) in the same direction and are extended to the first electrode (11) and the second electrode (22) via passing through two through-holes to form conductive connections.

12. An electronic cigarette comprising an atomization assembly (1) and a battery assembly (2) connected with the atomization assembly (1), and the atomization assembly (1) comprises:
an oil guide member (10);
a heating member (100) wound round the oil guide member (10);
a first electrically-conductive connecting member (101) and a second electrically-conductive connecting member (102) are being connected with two ends of the heating member (100) respectively;
wherein the heating member (100) includes at least one plane, and one plane in the at least one plane is attached to and wound towards an outside surface of the oil guide member (10) with a close fit.

13. The atomization assembly according to claim 12, wherein a cross section of the heating member (100) is polygonal.

14. The atomization assembly according to claim 13, wherein the cross section of the heating member (100) is rectangular;
the length of the cross section of the heating member (100) is ranged from 0.3 mm to 1 mm; and
the width of the cross section of the heating member (100) is ranged from 0.05 mm to 0.2 mm.

15. The atomization assembly according to claim 14, wherein two ends of the heating member (100) are riveted to the first electrically-conductive connecting member (101) and the second electrically-conductive connecting member (102) with riveting terminals (103) respectively.

16. The atomization assembly according to claim 15, wherein shapes of cross sections of the first electrically-conductive connecting member (101) and the second electrically-conductive connecting member (102) are polygon or circular respectively.

17. The atomization assembly according to claim 13, wherein the atomization assembly (1) further comprises a first electrode (11) and a second electrode (22); the first electrically-conductive connecting member (101) and the second electrically-conductive connecting member (102) are bent from two ends of the heating member (100) in the same direction and are extended to the first electrode (11) and the second electrode (22) to form conductive connections.

18. The atomization assembly according to claim 13, wherein the atomization assembly (1) is detachably connected with the battery assembly (2).

19. The atomization assembly according to claim 13, wherein the atomization assembly (1) and the battery assembly (2) are fixed to each other to form an integral forming structure.
